(19) United States
(12) Patent Application Publication
(10) Pub. No.: US 2009/0096374 A1
(43) Pub. Date: Apr. 16, 2009

(54) Plasma Display Panel

(76) Inventors: Yoshiho Seo, Kawasaki (JP); Kazushige Takagi, Kawasaki (JP); Tadayoshi Kosaka, Kawasaki (JP); Hajime Inoue, Kawasaki (JP); Koichi Sakita, Kawasaki (JP); Tomoyuki Nukumizu, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/909,464

(22) PCT Filed: Mar. 25, 2005
(86) PCT No.: PCT/JP2005/005501

§ 371 Date: Sep. 24, 2007

(51) Int. Cl. H01J 17/49

(52) U.S. Cl. 313/582

(57) ABSTRACT

A plasma display panel, having a discharge space between a first and a second substrates, includes a plurality of scan electrodes, each disposed along a display line, which can be driven individually and a plurality of address electrodes disposed to intersect with the above scan electrodes, and pixel areas at the intersecting positions of the scan electrodes and the address electrodes Further, the plasma display panel includes a sustain electrode for producing sustain discharge with the scan electrodes, and the sustain electrode is formed to have a grid shape. Each pixel area is surrounded with the grid shape.

### FIELD OF THE INVENTION

The present invention relates to a plasma display panel, and more particularly a plasma display panel suppressing a streaking phenomenon.

### BACKGROUND ART

A plasma display panel (hereafter referred to as PDP) produces an address discharge in a cell area, and thereafter, using wall charges produced by the above plasma discharge, performs tone display by repeating sustain discharges for a predetermined number of times. For this purpose, in principle, there are required two electrodes disposed in the horizontal and vertical directions for the address discharge, and two electrodes for the sustain discharge. The PDP currently in wide use is a three-electrode surface-discharge PDP, in which the electrode in the horizontal direction necessary for address discharge and one of the sustain electrodes are provided in common, thus having three electrodes in total.

Such the PDP is described, for example, in the following Patent documents 1, 2. The PDP described in these documents has an X electrode and a Y electrode formed on a front substrate in the horizontal direction, and an address electrode and a phosphor formed on a rear substrate in the vertical direction, so as to produce an address discharge between the Y electrode and the address electrode. Further, a sustain discharge is produced between the X electrode and the Y electrode. By the ultraviolet ray produced in the sustain discharge, the phosphor produces visible light, and the visible light is extracted to the outside through the front substrate.

[Patent document 1] The official gazette of the Japanese Unexamined Patent Publication No. 2004-193141.

[Patent document 2] The official gazette of the Japanese Unexamined Patent Publication No. Hei-4-75232.

### DISCLOSURE OF THE INVENTION

### Problems to be Solved by the Invention

As described above, in the PDP, the sustain discharge is produced between the X electrode and the Y electrode extending in the horizontal direction. In a region having a different display load ratio in the horizontal direction, therefore, there occurs a streaking phenomenon in which a luminance value in the region having a higher display load ratio becomes lower than a luminance value in the region having a lower display load ratio. Namely, in the X electrode and the Y electrode, a current flows due to the discharge, and when the display load ratio in the horizontal direction becomes high, sustain discharges occur in a larger number of pixels, which results in a larger current. With the above large current, a voltage drop is produced because of the resistance of the X electrode and the Y electrode, which causes a lowered discharge voltage of the pixels and the reduction of the luminance value. On the other hand, when the display load ratio in the horizontal direction is low, the magnitude of the current due to the discharge becomes low, and the voltage drop of the X electrode and the Y electrode becomes low, causing neither reduction of the discharge voltage of the pixels, nor reduction of the luminance value. Such the streaking phenomenon produces display having a stripe formed in the horizontal direction, which is therefore called streaking, and causes degraded image quality.

Accordingly, it is an object of the present invention to provide the PDP reducing image quality degradation caused by streaking.

### Means to Solve the Problems

In order to achieve the aforementioned object, according to a first aspect of the present invention, a plasma display panel having a discharge space between a first and a second substrate includes: a plurality of scan electrodes, each disposed along a display line, which can be driven individually; a plurality of address electrodes disposed to intersect with the above scan electrodes; and pixel areas disposed at the intersecting positions of the scan electrodes and the address electrodes. Further, the plasma display panel includes sustain electrodes for producing sustain discharges with the scan electrodes, and the sustain electrodes include first electrode areas disposed adjacent to the scan electrodes along the display lines, and a plurality of second electrode areas for coupling the first electrode areas at a plurality of points of the display lines.

According the above first aspect, the sustain electrodes producing sustain discharges with the scan electrode are configured of the first electrode areas and the second electrode areas for coupling the first electrode areas at a plurality of points, and thereby voltage drop at the sustain electrodes in each display line caused by the discharge current can be made equal irrespective of the display pattern. Thus the streaking phenomenon can be reduced.

In order to achieve the aforementioned object, according to a second aspect of the present invention, a plasma display panel having a discharge space between a first and a second substrate includes: a plurality of scan electrodes, each disposed along a display line, which can be driven individually; a plurality of address electrodes disposed to intersect with the above scan electrodes; and pixel areas at the intersecting position of the scan electrodes and the address electrodes. Further, the plasma display panel includes sustain electrodes for producing sustain discharge with the scan electrodes, wherein the sustain electrodes are formed in a grid shape, and each pixel area is surrounded by the grid shape.

According the above second aspect, by forming the sustain electrodes in a grid shape so as to surround the pixel areas, voltage drop at the sustain electrodes in each display line caused by the discharge current can be made equal irrespective of the display pattern. Thus, the streaking phenomenon can be reduced. Further, because the sustain electrodes are provided outside the pixel areas, the electrode width thereof extending in the display line direction can be increased, so that the wiring resistance of the electrode can be reduced. Thus, the streaking phenomenon can be suppressed. Moreover, only the scan electrodes are provided in the pixel areas, and the sustain electrode is not provided therein. Therefore, the electrode widths of the scan electrodes can be increased, and voltage drop caused by the discharge current on the scan electrode side can be suppressed. Thus, the streaking phenomenon can be restrained.

In the above second aspect, according to a preferred embodiment, the grid-shaped ribs are formed to surround the pixel areas, and the grid-shaped sustain electrodes are disposed to overlap the ribs. By overlaying the grid-shaped sustain electrodes on the grid-shaped ribs surrounding the pixel areas, the sustain electrodes do not shield the pixel areas, and thus the aperture ratio can be increased. In case of an embodiment of reflection type in which a phosphor is provided on the rear substrate side, visible light illuminated from the phosphor is not intercepted by the sustain electrodes.

In order to achieve the aforementioned object, according to a third aspect of the present invention, a plasma display panel having a discharge space between a first and a second substrate includes: a plurality of scan electrodes, each disposed along a display line, which can be driven individually; a plurality of address electrodes disposed to intersect with the above scan electrodes; pixel areas at the intersecting position of the scan electrodes and the address electrodes; and a sustain electrode for producing sustain discharge with the scan electrodes. Further, the sustain electrode includes first electrode areas disposed between the display lines and a plurality of second electrode areas for coupling the adjacent first electrode areas at a plurality of points.

In the above third aspect also, the voltage drop of the sustain electrodes in the display line direction can be made equal irrespective of the display pattern, and the streaking phenomenon can be reduced accordingly.

### EFFECTS OF THE INVENTION

According to the present invention, a plasma display panel having a reduced streaking phenomenon can be provided.

### BRIEF DESCRIPTION OF THE DRAWINGS

FIG. 1 shows the plan view of the conventional PDP.

FIG. 2 shows a diagram illustrating a streaking phenomenon.

FIG. 3 shows a diagram illustrating a PDP structure according to a first embodiment.

FIG. 4 shows a diagram illustrating a PDP structure according to a second embodiment.

FIG. 5 shows a diagram illustrating a deformed example of the PDP structure according to the second embodiment.

FIG. 6 shows a diagram illustrating another deformed example of the PDP structure according to the second embodiment.

FIG. 7 shows a diagram illustrating a PDP structure according to a third embodiment.

FIG. 8 shows a diagram illustrating an improved example of the second embodiment.

FIG. 9 shows a diagram illustrating a different improved example of the second embodiment.

FIG. 10 shows a diagram illustrating a different improved example of the second embodiment.

FIG. 11 shows a diagram illustrating a different improved example of the second embodiment.

### DESCRIPTION OF REFERENCE NUMERALS

10: front substrate 20: rear substrate A0-A2: address electrodes Y0, Y1: scan electrodes X: sustain electrode RB1, RB2: ribs

### PREFERRED EMBODIMENTS OF THE INVENTION

The preferred embodiment of the present invention is described hereinafter referring to the charts and drawings. However, it is noted that the technical scope of the present invention is not limited to the embodiments described below, but embraces items described in the claims and the equivalents thereof.

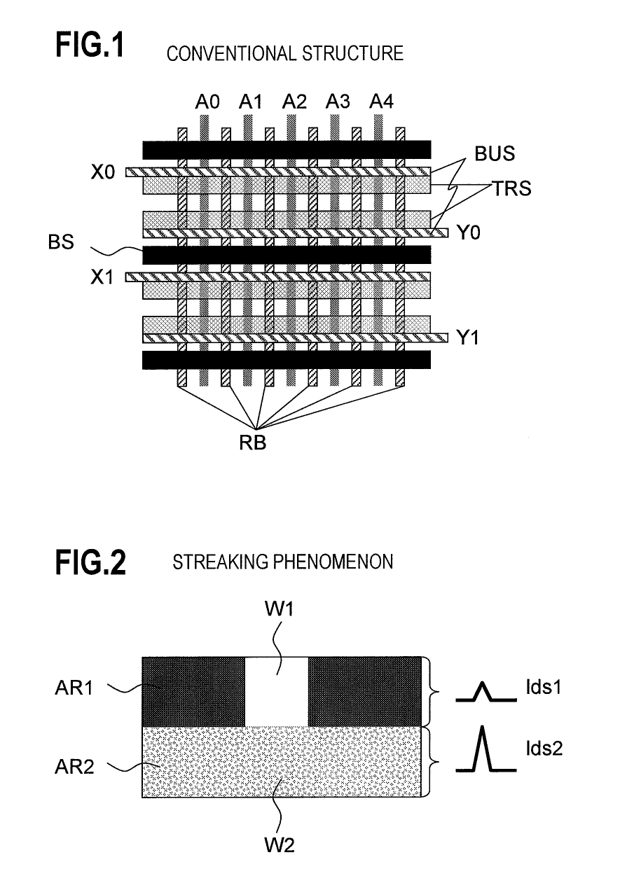

FIG. 1 shows the plan view of the conventional PDP. For simplicity, the cross sectional view is omitted. The PDP is a three-electrode surface-discharge AC-PDP, having address electrodes A0-A4 extending in the vertical direction, ribs RB extending in the vertical direction between the address electrodes, and phosphor layers (not shown) disposed on the address electrodes on the rear substrate. Further, on the front substrate, there are formed X electrodes X0, X1 and Y electrodes Y0, Y1, extending in the horizontal direction. The X electrode and the Y electrode are both configured of transparent electrodes TRS, and bus electrodes BUS formed of metal electrodes being overlaid on the transparent electrodes TRS. Ordinarily, the material used for the transparent electrodes TRS has a larger resistance value than the bus electrodes BUS formed of metal electrodes. The Y electrode is a scan electrode. In synchronization with the scanning timing of the Y electrode, voltage is applied to an address electrode, thereby producing an address discharge in each pixel area in which the Y electrode intersects with the address electrode. Further, the X electrode is a sustain electrode, and produces a sustain discharge between with the Y electrode. In other words, the Y electrode is used in common as scan electrode and sustain electrode. Moreover, on the front substrate, a dark-colored black stripe BS for shielding light is disposed between X, Y electrode pairs, to prevent a phosphor color on the rear substrate from being leaked to the front surface side.

FIG. 2 shows a diagram illustrating a streaking phenomenon. In the present example, there are shown a display pattern, in which a white display area W1 exists only in the central portion of a portion AR1 of the PDP area, while in another area AR2, the entire area becomes a white display area W2. In the above case, a sustain discharge is produced only in a portion W1 of the area AR1, and accordingly, a discharge current Ids1 required for the sustain discharge is relatively small. In contrast, in the area AR2, the sustain discharge is produced throughout the entire portions W2, and accordingly, a discharge current Ids2 becomes larger than the above discharge current Ids1. Therefore, the voltage drop at the X, Y electrodes in the area AR2 becomes larger than the voltage drop at the X, Y electrodes in the area AR1, causing a reduced discharge voltage in each cell area. As a result, even though an identical number of times of sustain discharges are made in the white display areas W1, W2, the luminance in the white display area W2 becomes smaller than the luminance in the white display area W1, and thus a stripe-shaped display is made in the area W2, which is the streaking phenomenon.

Namely, the streaking phenomenon in PDP is a phenomenon in which the image quality is deteriorated because of incapability of producing identical luminance, due to a different voltage drop at the X, Y electrodes used for the sustain discharge depending on a display pattern. Therefore, it is necessary to reduce an electrode wiring resistance causing the streaking phenomenon. Alternatively, it is necessary to reduce the phenomenon of a different voltage drop in between the X and Y electrodes depending on a display pattern.

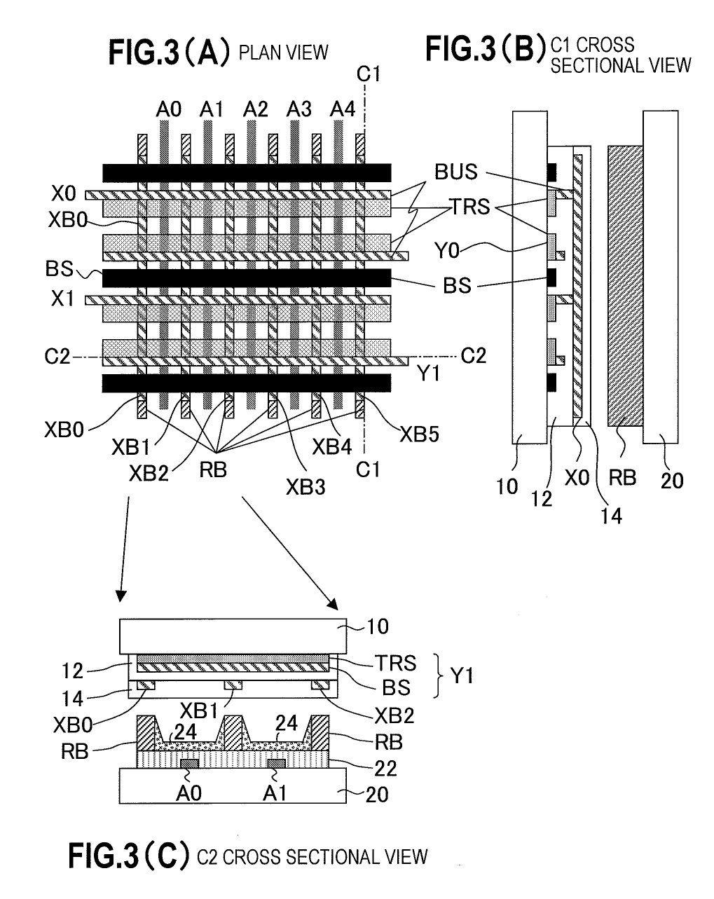

FIG. 3 shows a diagram illustrating a PDP structure according to a first embodiment. FIG. 3(A) is a plan view, and FIGS. 3(B), 3(C) are C1 and C2 cross-sectional views, respectively. In the plan view (A), unlike the plan view shown in FIG. 1, X electrodes XB0-XB5 are disposed in the vertical direction along the ribs RB, and the X electrodes X0, X1 in the horizontal direction are mutually coupled with the X electrodes XB0-XB5 in the vertical direction at a plurality of points. With the above X electrodes XB0-XB5, the X electrode is of grid shape.

On front substrate 10, there are provided X electrodes X0, X1, and also Y electrodes Y0, Y1, constituted of transparent electrodes TRS formed of ITO and bus electrodes BS having three-layer structure of Cr/Cu/Cr formed on the transparent electrode TRS. Such a pair of X, Y electrodes are electrodes to be used for sustain discharge, so as to perform sustain discharge therebetween. Further, a dark-colored black stripe BS is disposed in a non-illumination area between the X, Y electrode pairs. The above X, Y electrodes and the black stripe BS are coated with a dielectric layer 12. Further, on the dielectric layer 12, X electrodes XB0-XB5 are disposed in the vertical direction. The above X electrodes in the vertical direction are also electrodes having three-layer structure of Cr/Cu/Cr, which are connected at a plurality of points to the bus electrodes BUS of the X electrodes disposed in the horizontal direction. However, the above X electrodes intersect with the Y electrodes without being connected thereto. Further, a dielectric layer 14 is formed also on the X electrodes disposed in the vertical direction.

On rear substrate 20, address electrodes A0-A4 are formed, and also a dielectric layer 22 is formed thereon. On dielectric layer 22, stripe-shaped ribs RB are formed to demarcate pixel areas, and a phosphor layer 24 is formed on the address electrodes and dielectric layer 22, and on the ribs RB.

The X electrodes XB0-XB5 disposed in the vertical direction on front substrate 10 are laid out in such positions as being overlaid on the ribs RB of rear substrate 20. The ribs RB are non-illumination areas for demarcating the pixel areas, and by overlaying the X electrodes XB0-XB5 thereon, the reduction of the aperture ratio is prevented.

According to the present embodiment, the X electrodes X0, X1 in the horizontal direction are coupled with the X electrodes XB0-XB5 disposed in the vertical direction at the plurality of points. Therefore, at the sustain discharge, the voltage drop of each X electrode in the horizontal direction becomes equivalent irrespective of a display pattern, enabling reduction of the streaking phenomenon. As such, at sustain discharge, a voltage drop difference depending on a display pattern is eliminated at X electrodes, which are one electrodes among the X, Y electrodes used for sustain discharge. Accordingly, the streaking phenomenon is reduced to almost half.

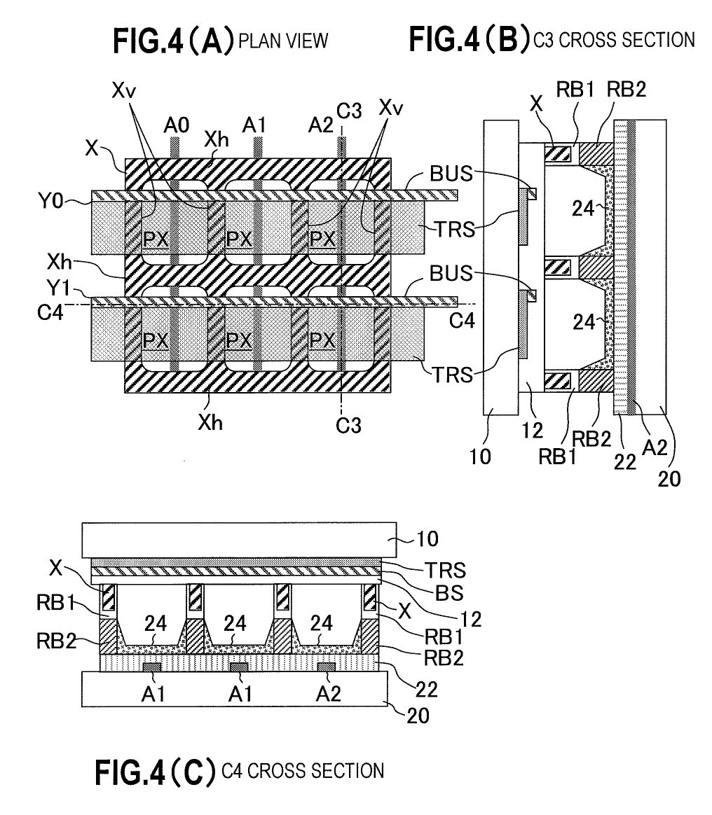

FIG. 4 shows a diagram illustrating a PDP structure according to a second embodiment. Similar to FIG. 3, the plan view (A), and cross-sectional views (B), (C) are illustrated. In the present embodiment, on front substrate 10, Y electrodes Y0, Y1 each having a bus electrode BUS overlaid on a transparent electrode TRS are disposed along a display line, with a dielectric layer 12 coated thereon. Further, on dielectric layer 12, grid-shaped ribs RB1 are formed, and an X electrode X is buried in each rib RB1. The above each grid-shaped ribs RB1 are formed to surround pixel areas PX. Meanwhile, on rear substrate 20, address electrodes A0-A2, dielectric layer 22 for coating the address electrodes A0-A2, and grid-shaped ribs RB2 are formed. Further, phosphors 24 are formed on dielectric layer 22 and the ribs RB2. The ribs RB2 on the rear substrate side are respectively disposed opposite to the rib RB1 on the front substrate side, and with the above ribs RB1 and RB2, each pixel area PX is demarcated.

Because the grid-shaped X electrode is formed in an overlapped manner on the ribs RB1, RB2, the visible light illuminated in the pixel area is not intercepted. Also, because the X electrode is configured of an electrode portion Xh extending in the horizontal direction between the display lines and a plurality of electrode portions Xv extending in the vertical direction between the address electrodes, it is possible to prevent from a different voltage drop on the X electrode in each display line depending on the display pattern.

Further, according to the second embodiment, for example, the X electrode is formed of metal wiring having three-layer structure of Cr/Cu/Cr and formed in an overlapped manner on the rib RB1, the width of the above metal wiring can be made greater than in the first embodiment. Thus, the wiring resistance of the X electrode can be reduced. Also, because only the Y electrode is formed in the pixel area PX, the wiring width of the bus electrode BUS portion can be made greater, and thus, the wiring resistance can be reduced. Namely, it is possible to suppress the streaking phenomenon caused by the voltage drop in the Y electrode.

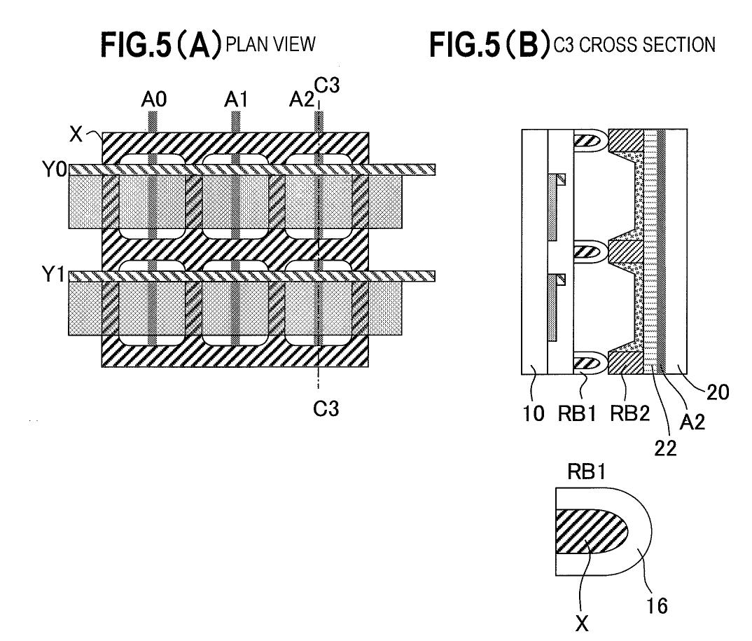

FIG. 5 shows a diagram illustrating a deformed example of the PDP structure of the second embodiment. In this figure, only a plan view (A) and a C3 cross-sectional view (B) are shown. In the second embodiment, as described earlier, the grid-shaped X electrode X is formed in an overlapped manner on the grid-shaped rib RB1 on front substrate 10. The structure of the above rib RB1 includes the X electrode X formed in a rib shape by silver paste, and a dielectric layer 16 coated thereon. Namely, by forming the X electrode X in a rib shape by silver paste, the cross section area is increased, and thereby the wiring resistance is reduced. Further, by forming thin dielectric layer 16 on the surface of the rib-shaped X electrode X, the capacity of the X electrode is made greater, so as to increase the amount of wall charges deposited at the time of a sustain discharge. The structure other than the above is equivalent to the structure shown in FIG. 4. The cross-sectional view in the horizontal direction is identical to that shown in FIG. 3(C), except that the structure of the rib RB1 is identical to the structure shown in the cross-sectional view (B).

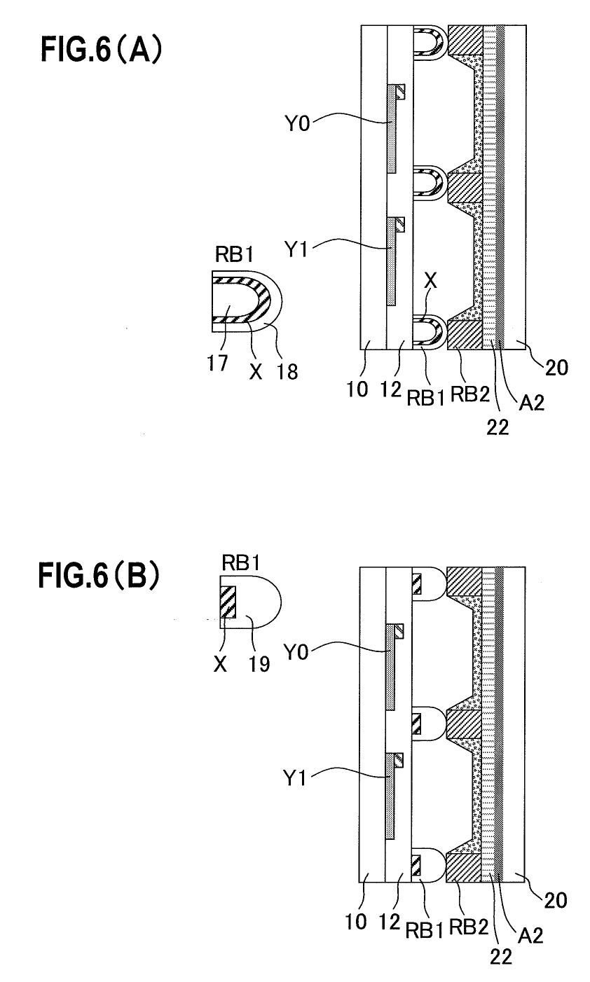

FIG. 6 shows a diagram illustrating another deformed example of the PDP structure of the second embodiment. In FIG. 6, two cross-sectional views corresponding to the cross-sectional view shown in FIG. 5 are shown. Only the structure of the rib RB1 is different, and other structure is identical to that shown in FIG. 5.

In FIG. 6(A), the structure of the rib RB1 on front substrate 10 is shown in enlargement. Each rib RB1 includes a rib-shaped dielectric 17, a thin-film X electrode X formed on the surface of the rib RB1 by silver paste, and further, a thin-film dielectric layer 18. In this case also, by forming the X electrode X with a sufficient cross-section area, and thin-film dielectric layer 18 over a wide area on the surface thereof, the capacity of the X electrode is increased.

In FIG. 6(B), the structure of the rib RB1 on front substrate 10 is shown in enlargement. The rib RB1 includes an X electrode X having three-layer structure of Cr/CU/Cr formed on dielectric layer 12, and a rib-shaped dielectric 19 formed thereon. In this case, to prevent the capacity reduction of the X electrode, rib-shaped dielectric 19 is formed of a substance having a high dielectric constant.

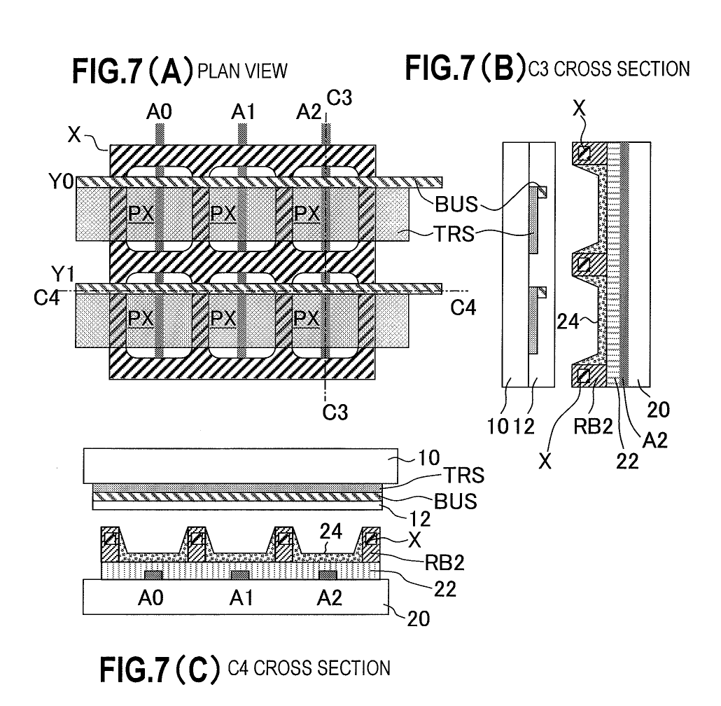

FIG. 7 shows a diagram illustrating a PDP structure according to a third embodiment. The plan view shown in FIG. 7(A) is identical to the second embodiment shown in FIG. 4. A grid-shaped X electrode X is formed in such a manner as to demarcate pixel areas PX, and Y electrodes Y0, Y1 are formed to penetrate through the pixel areas PX in the horizontal direction. Each Y electrode is formed of a transparent electrode TRS and a bus electrode BUS.

As shown in the cross-sectional views of FIGS. 7(B), (C), according to the third embodiment, the grid-shaped X electrode X is formed inside the rib RB2 of rear substrate 20. In contrast, no rib is formed on the front substrate 10 side. More specifically, on an upper portion of the rib RB2 formed of glass material, the X electrode X of Cr/Cu/Cr structure is formed, which is further coated with a dielectric layer. The forming method of such the rib RB2 is as follows: For example, a glass paste is coated and baked, and Cr/Cu/Cr structure is formed thereon by means of a sputtering method, and using a mask formed thereon, the Cr/Cu/Cr structure is etched to form a grid shape. Thereafter, using the above grid-shaped X electrode as a mask, a dielectric layer is etched by means of a sandblast method, and finally, a thin dielectric layer such as SiO₂ is formed by means of a CVD method. Forming the X electrode X on a vertex portion of the rib RB2 of rear substrate 20 enables the X electrode X to approach the Y electrode of front substrate 10, thereby facilitating the generation of a sustain discharge.

According to the third embodiment also, since the grid-shaped X electrode is formed in an overlapped manner on the rib RB2 on the rear face side, it is possible to increase the width of the X electrode, enabling the reduction of resistance. Further, since the X electrode is not disposed in the pixel area PX, the aperture ratio can be increased. By increasing the bus electrode width of the Y electrode, the wiring resistance thereof can be reduced, thereby enabling the reduction of the streaking phenomenon caused by the voltage drop of the Y electrode. Also, since a rib is not formed on front substrate 10, the alignment between the front substrate and rear substrate 20 can be made between the Y electrode and rib RB2, which makes it tolerable to degrade alignment accuracy, as compared to the second embodiment in which grid-shaped ribs are to be mutually aligned.

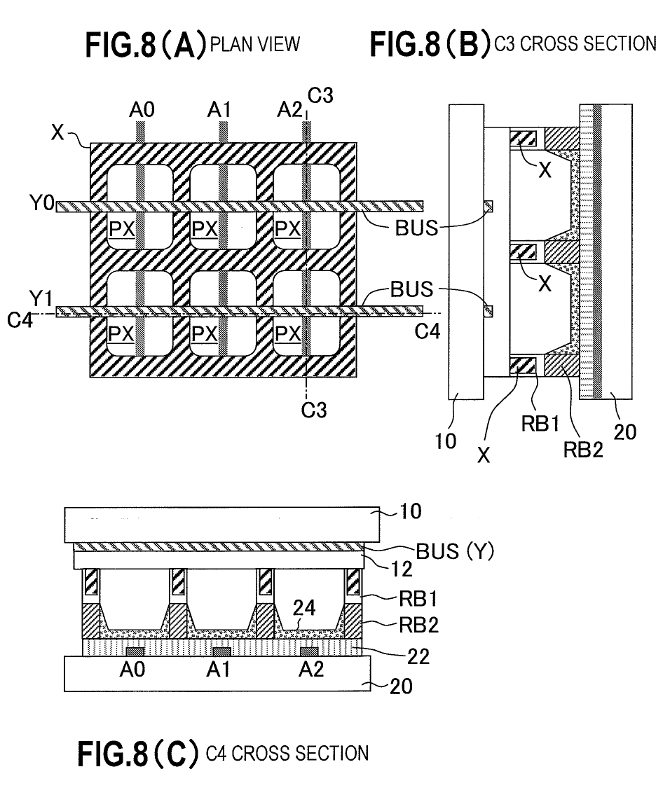

FIG. 8 shows a diagram illustrating an improved example of the second embodiment. In the present improved example, the structure of the Y electrode in the second embodiment shown in FIG. 4 is modified. In the example shown in FIG. 8, the Y electrodes Y0, Y1 are configured of only bus electrodes BUS having three-layer structure of Cr/Cu/Cr, which are further disposed at the central position of each pixel area PX demarcated by a grid-shaped X electrode X. No transparent electrode is provided.

In the present improved example, since the X electrode is formed to have a grid shape surrounding each pixel area, the Y electrode is configured of only bus electrode BUS at the central portion of the pixel area PX, so that a sustain discharge is produced between with the X electrode located at the upper and lower positions of the bus electrode BUS. With the grid-shaped X electrode X not being disposed inside the pixel area PX, the reduction of the aperture ratio does not largely occur even if the Y electrode is disposed at the central portion of the pixel area PX. Also, because of disposing the Y electrode at the center of the aperture portion of the grid-shaped X electrode, instead of disposing the X electrode and the Y electrode on both upper limit ends of the pixel area as in the conventional example, the distance between the X and Y electrodes can be shortened, so as to enable the sustain discharge.

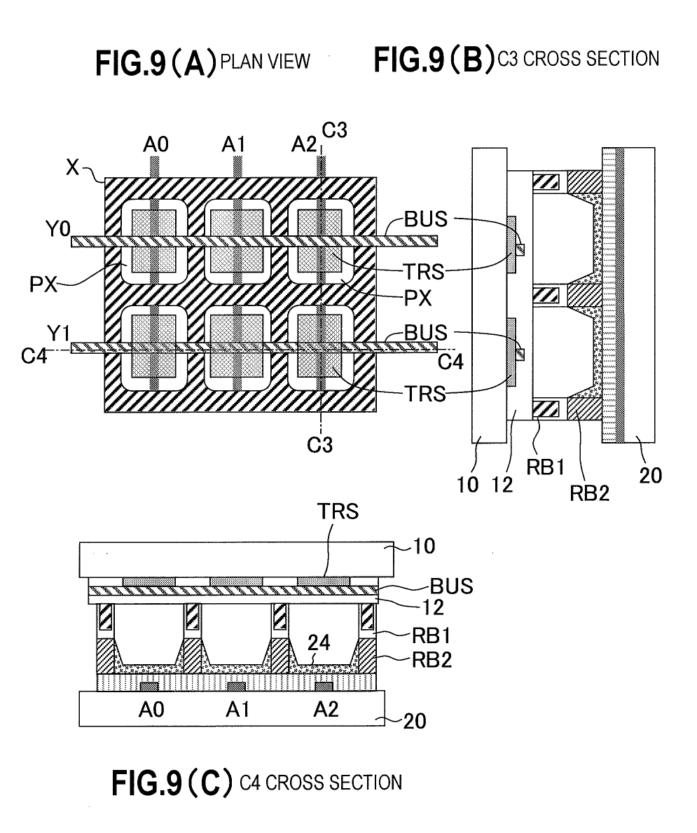

FIG. 9 shows a diagram illustrating a different improved example of the second embodiment. In the present improved example also, the structure of the Y electrode in the second embodiment shown in FIG. 4 is modified. In the example shown in FIG. 9, the Y electrodes Y0, Y1 are configured of bus electrodes having three-layer structure of Cr/Cu/Cr and transparent electrodes TRS each positioned inside the pixel area PX demarcated by a grid-shaped X electrode X. Further, each bus electrode BUS is disposed at the central position of the pixel area PX. With the above structure of the Y electrode, it is possible to produce a sustain discharge between with the X electrode disposed in the upper and lower positions of the Y electrode. Also, by providing the transparent electrode TRS, it is possible to shorten the distance between the Y electrode and the X electrode without reducing the aperture ratio. Further, by providing the transparent electrode TRS separately for each pixel area PX, the area of the X electrode in the vertical direction overlapping the Y electrode is minimized. If the distance between the X and Y electrodes is too short, the sustain discharge does not occur. Therefore, even though the area overlapping the X electrode in the vertical direction is eliminated, by separating the transparent electrode TRS of the Y electrode on a basis of each pixel area the sustain discharge efficiency is not degraded. Rather, by reducing the overlap area with the X electrode, the capacitance between the X and Y electrodes is reduced, thereby enabling to reduce power required for the sustain discharge.

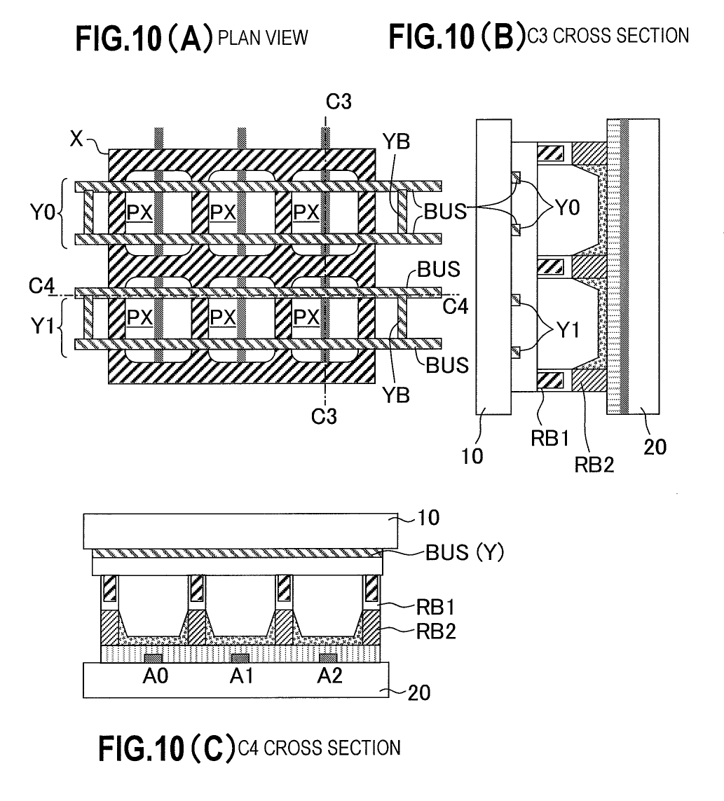

FIG. 10 shows a diagram illustrating a different improved example of the second embodiment. In the present improved example also, the structure of the Y electrode in the second embodiment shown in FIG. 4 is modified. In the example shown in FIG. 10, each Y electrode Y0, Y1 is configured of two upper and lower bus electrodes BUS and a coupling electrode YB for coupling the two bus electrodes BUS. By disposing the bus electrodes BUS respectively in the upper and lower positions of the pixel areas PX, the distance between the Y electrode and the X electrode can be shortened, and thus the sustain discharge voltage can be reduced. Here, the coupling electrode YB is provided for equating the voltages of the Y electrode on an identical display line. It may also be possible to dispose the coupling electrodes YB in the vertical direction in a plurality of lines so as to overlap the ribs RB1, RB2 which extend in the vertical direction.

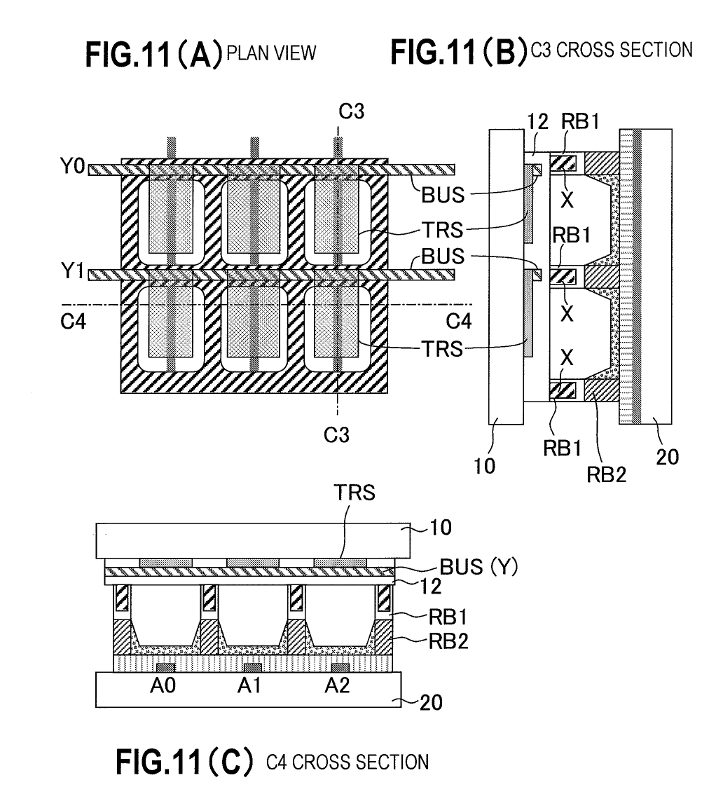

FIG. 11 shows a diagram illustrating a different improved example of the second embodiment. In the present improved example, the structure of the Y electrode in the second embodiment shown in FIG. 4 is modified. In the example shown in FIG. 11, the Y electrode is configured of a bus electrode BUS having three-layer structure of Cr/Cu/Cr and transparent electrodes TRS separated for each pixel area. Also, the bus electrode BUS is disposed under the rib RB1. As such, without providing the bus electrode BUS, which is a metal electrode, inside the pixel area, the visible light illuminated from the phosphor in the pixel area is not shielded, enabling increase of emission luminance. Here, in this case, the X electrode X in the rib RB1 is disposed in parallel with the bus electrode BUS of the Y electrode disposed thereunder at a distance of a thin dielectric layer 12. Therefore, it is necessary to decrease the dielectric constant of dielectric 12, so that interline capacitance between the X and Y electrodes is not increased.

In the example shown in FIG. 11, if the rib RB1 has a structure shown in FIG. 6(A), it is possible to thicken the dielectric layer between the bus electrode BUS of the Y electrode provided under the rib RB1 and the X electrode, and thus, the capacitance between both electrodes can be lessened.

Also in FIG. 11, since the transparent electrode TRS is spread in each pixel area, the distance between the above transparent electrode TRS and the X electrode can be shortened, and accordingly, it is possible to increase the occurrence efficiency of the sustain discharge. Also, because the transparent electrode TRS is located close to the grid-shaped X electrode in a wider area, it is possible to enlarge the sustain discharge area.

The deformed examples of the Y electrode shown in FIGS. 9 through 11 are similarly applicable to the third embodiment shown in FIG. 7. In such the cases, the merits described in FIGS. 9 through 11 are similarly obtainable.

Additionally, the material of the metal electrode is not limited to those described in the aforementioned embodiments, as long as being a conductive material.

### INDUSTRIAL APPLICABILITY

According to the present invention, it is possible to reduce the streaking phenomenon and enhance image quality.

What is claimed is:

1. A plasma display panel having a discharge space between a first and a second substrate, comprising:
a plurality of scan electrodes, each disposed along a display line, which can be driven individually;
a plurality of address electrodes disposed to intersect with the scan electrodes; and
pixel areas disposed at the intersecting positions of the scan electrodes and the address electrodes,
the plasma display panel further comprising:
sustain electrodes for producing sustain discharges with the scan electrodes,
wherein the sustain electrodes include first electrode areas disposed adjacent to the scan electrodes along the display lines, and a plurality of second electrode areas for coupling the first electrode areas at a plurality of points of the display lines.

2. The plasma display panel according to claim 1,
wherein the scan electrodes and the sustain electrodes are formed on the first substrate, while the address electrodes are formed on the second substrate, and
wherein, on the second substrate, ribs extending in the vertical direction relative to the display lines are provided on both sides of the address electrodes, and
wherein the second electrode areas of the sustain electrodes are disposed in the positions overlapping the ribs.

3. The plasma display panel according to claim 1,
wherein the first and the second electrode areas of the sustain electrodes are disposed in such a manner as to surround the pixel areas.

4. The plasma display panel according to claim 1,
wherein the scan electrodes are formed on the first substrate, while the address electrodes are formed on the second substrate, and
wherein ribs are formed on the first substrate to demarcate each pixel area, and the first and the second electrode areas of the sustain electrodes are formed in such a manner as either overlapping the ribs or contained in the ribs.

5. A plasma display panel having a discharge space between a first and a second substrate, comprising:
a plurality of scan electrodes, each disposed along a display line, which can be driven individually;
a plurality of address electrodes disposed to intersect with the scan electrodes; and
pixel areas at the intersecting positions of the scan electrodes and the address electrodes,
the plasma display panel further comprising:
sustain electrodes for producing sustain discharges with the scan electrodes,
wherein the sustain electrodes are formed in a grid shape, and each pixel area is surrounded by the grid shape.

6. A plasma display panel having a discharge space between a first and a second substrate, comprising:
a plurality of scan electrodes, each disposed along a display line, which can be driven individually;
a plurality of address electrodes disposed to intersect with the scan electrodes; and
pixel areas at the intersecting positions of the scan electrodes and the address electrodes,
the plasma display panel further comprising:
sustain electrodes for producing sustain discharges with the scan electrodes,
wherein the sustain electrodes include first electrode areas disposed between the display lines, and a plurality of second electrode areas for coupling the adjacent first electrode areas at a plurality of points.

7. The plasma display panel according to claim 5 or 6,
wherein grid-shaped ribs are formed to surround the pixel areas, and the grid-shaped sustain electrodes are disposed to overlap the ribs.

8. The plasma display panel according to claim 5 or 6,
wherein the scan electrodes are formed on the first substrate, while the address electrodes are formed on the second substrate, and
wherein grid-shaped ribs are formed on the first substrate, and the sustain electrodes are formed in the rib, and dielectric layers are formed on the surface of the sustain electrodes.

9. The plasma display panel according to claim 8,
wherein the ribs include dielectric layers also under the sustain electrodes.

10. The plasma display panel according to claim 5 or 6,
wherein the scan electrodes are formed on the first substrate, while the address electrodes are formed on the second substrate, and
wherein grid-shaped ribs are formed on the second substrate, and the sustain electrodes are formed in the ribs, and dielectric layers are formed on the surface of the sustain electrodes.

11. The plasma display panel according to claim 5 or 6,
wherein the scan electrodes are configured of bus electrodes disposed at the center of the pixel areas.

12. The plasma display panel according to claim 11,
wherein the scan electrodes include a plurality of transparent electrodes overlaid on the bus electrodes and separated for each pixel area.

13. The plasma display panel according to claim 5 or 6,
wherein the scan electrodes are configured of bus electrodes separately disposed in the upper end portions and the lower end portions of the pixel areas.

14. The plasma display panel according to claim 5 or 6,
wherein the scan electrodes are formed on the first substrate, while the address electrodes are formed on the second substrate, and
wherein grid-shaped ribs are formed on the first substrate, and the sustain electrode is formed in the ribs, and
wherein the scan electrodes include bus electrodes disposed to underlay the rib in a layered manner, and a plurality of transparent electrodes overlaid on the bus electrodes and separated for each pixel area.
